(19) United States
(12) Patent Application Publication
(10) Pub. No.: US 2021/0334813 A1
(43) Pub. Date: Oct. 28, 2021

(54) SYSTEMS AND METHODS FOR MONITORING HEALTH AND COGNITIVE ABILITY OF A CUSTOMER

(71) Applicant: Wells Fargo Bank, N.A., San Francisco, CA (US)

(72) Inventors: Christopher P. Clausen, Novato, CA (US); Andrew J. Garner,, IV, State Road, NC (US); Benjamin Geertz, Milwaukie, OR (US); Bryan Kroll, San Mateo, CA (US); Muhammad Farukh Munir, Pittsburg, CA (US); Daniel Haruki Oshima, San Francisco, CA (US)

(21) Appl. No.: 15/612,462

(22) Filed: Jun. 2, 2017

Related U.S. Application Data
(60) Provisional application No. 62/492,067, filed on Apr. 28, 2017.

(51) Int. Cl. G06Q 20/40; G06Q 20/10

(52) U.S. Cl. CPC G06Q 20/40145; G06Q 20/1085

(57) ABSTRACT

A banking system includes a connected device comprising a biometric sensor and a computer system communicatively coupled to the connected device. The connected device is configured to receive, via the biometric sensor, biometric data associated with a biometric condition of a customer of a financial institution. The computer system is configured to receive the biometric data, receive location data associated with a position of the customer, generate a health score of the customer in response to receiving a transaction request, determine a biometric state of the customer based on at least one of the health score exceeding a predetermined threshold of a base score or the position of the customer during a financial transaction, and transmit an account alert to a third party prior to authorizing the transaction request based on the biometric state of the customer.

### CROSS-REFERENCE TO RELATED APPLICATIONS

This application claims the benefit of priority to U.S. Application No. 62/492,067 filed Apr. 28, 2017, entitled “SYSTEMS AND METHODS FOR MONITORING HEALTH AND COGNITIVE ABILITY OF A CUSTOMER”, which is hereby incorporated by reference in its entirety.

### BACKGROUND

Generally, when a customer wishes to complete a transaction, such as withdrawing funds from an automated teller machine (ATM) or transferring funds to another party, the customer mutually consents to the transaction. In some instances, the customer may be forced to engage in the transaction by another party who may be a caregiver or family member. The customer may be compelled or otherwise coerced to withdraw or transfer funds for the benefit of the third party out of fear of injury, bodily harm, or death. For example, a caregiver may threaten to harm the customer if the customer does not give the caregiver funds. In turn, the customer may go to the ATM, authenticate himself or herself to the ATM, and withdraw funds to give to the other party. In such examples, the coerced transaction may remain undetected or discovered after the transaction has been completed.

### SUMMARY

One embodiment relates to a method of determining a biometric state of a customer during a financial transaction. The method includes receiving, via a connected device, biometric data associated with a biometric condition of a customer of a financial institution; generating, via the connected device, a base score based on biometric data acquired during a first time period; generating, via the connected device, a health score of the customer based on biometric data acquired during a second time period in response to receiving a transaction request; determining, via the connected device, that the health score exceeds a predetermined threshold of the base score; and transmitting, via the connected device, an account alert to a recipient associated with the customer prior to authorizing the transaction request in response to the determination that the health score exceeds the predetermined threshold of the base score.

One embodiment relates to a banking system. The banking system includes a connected device comprising a biometric sensor and a computer system communicatively coupled to the connected device. The connected device is configured to receive, via the biometric sensor, biometric data associated with a biometric condition of a customer of a financial institution. The computer system is configured to receive the biometric data, receive location data associated with a position of the customer, generate a health score of the customer in response to receiving a transaction request, determine a biometric state of the customer based on at least one of the health score exceeding a predetermined threshold of a base score or the position of the customer during a financial transaction, and transmit an account alert to a third party prior to authorizing the transaction request based on the biometric state of the customer.

One embodiment relates to a connected system for determining a biometric state of a customer. The connected system includes a computer system associated with a financial institution and a connected device communicatively coupled to the computer system. The connected device is configured to receive biometric data associated with a biometric condition of a customer of the financial institution, generate a base score of the customer based on the biometric data, generate a health score of the customer in response to the transaction request received, determine a biometric state of the customer based on the health score exceeding a predetermined threshold of the base score, and place a hold on an account of the customer based on the biometric state of the customer.

These and other features, together with the organization and manner of operation thereof, will become apparent from the following detailed description when taken in conjunction with the accompanying drawings.

### BRIEF DESCRIPTION OF THE FIGURES

FIG. 1 is a block diagram of a connected system for a financial institution according to an example embodiment.

FIG. 2a is a block diagram of the connected device of the connected system according to an example embodiment.

FIG. 2b is a block diagram of the location device of the connected system according to an example embodiment.

FIG. 3 is a flow diagram of a method of determining a biometric state of a customer during a financial transaction.

### DETAILED DESCRIPTION

Referring to the figures generally, systems and methods of determining a biometric state of a customer of a financial institution are described. A connected device (e.g., a wearable) may receive biometric data associated with a biometric condition (e.g., the health or cognitive condition of the customer derived by indicators such as, but not limited to, vital signs, pulse rate, body temperature, blood pressure, etc.) of the customer of the financial institution. The connected device may generate a base score based on the biometric data received. As the connected device monitors the biometric condition of the customer, the connected device may generate a health score associated with the customer. The base score and the health score may be used by the connected device to determine a biometric state (e.g., a state of duress, coercion, fraud, or a combination thereof) of the customer which, in turn, determines a fraud victim risk level of a customer and detects potential coercion of the customer when conducting a financial transaction by a caregiver or other third party.

The embodiments and implementations of the systems and methods disclosed herein improve current computing systems for determining a biometric state of a customer of a financial institution to actively detect fraudulent and/or coercive transactions. These systems, methods, and computer implementations improve such computing systems by determining a biometric state of a customer of a financial institution to improve the fields of computing systems, data privacy systems, security systems, and information management. As such, the systems, methods, and computer implementations disclosed herein improve the functioning of such systems and information management by providing functionalities that are novel and non-obvious improvements over current systems.

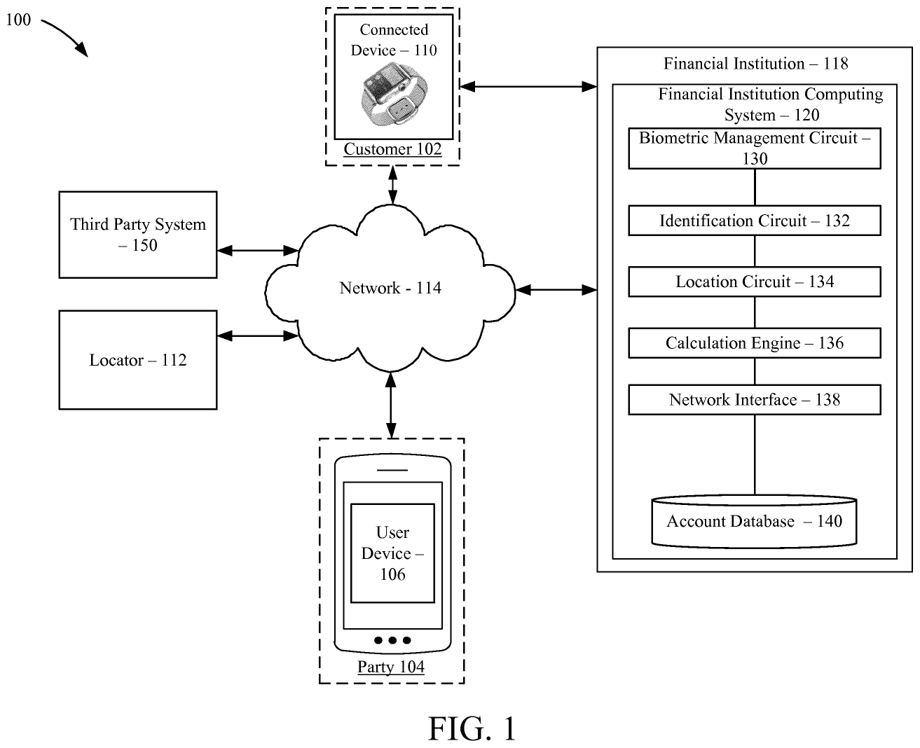

Referring to FIG. 1, a block diagram of a connected system 100 for a financial institution is shown according to an example embodiment. Generally, the financial institution provides financial services (e.g., demand deposit accounts, credit accounts, etc.) to a plurality of customers. The connected system 100 includes the connected device 110, locator 112, network 114, financial institution computing system 120, and user device 106. In some embodiments, the connected system 100 may include a third party system 150. The financial institution provides banking services to the customers, for example, customers can deposit funds into accounts, withdraw funds from accounts, transfer funds between accounts, view account balances, and the like.

As described in further detail herein, the connected system 100 includes the connected device 110 (e.g., a wearable) that may monitor various biological conditions of the customer. For example, the connected device 110 may monitor the pulse rate, body temperature, blood pressure, etc. of the customer. The connected device 110 is structured to facilitate customer transactions via the financial institution computing system 120. In some configurations, the connected device 110 may include or otherwise be configured to interface with various components (e.g., a webcam, breathalyzer, eye tracker, scent detector) to detect an impairment associated with the mental awareness of the customer.

As described in further detail herein, the connected device 110 may also interface with the third party system 150 and/or or locator 112 to facilitate the monitoring of the biometric conditions (e.g., vital signs, pulse rate, body temperature, blood pressure, or a combination thereof) of the customer.

The financial institution computing system 120 is a backend computer system that supports the connected device 110 and other financial services offered by the financial institution. Accordingly, the financial institution computing system 120 includes a network interface 138, a biometric management circuit 130, an identification circuit 132, a location circuit 134, a calculation engine 136, and an account database 140. The connected device 110 is structured to monitor the biologic conditions (e.g., pulse rate, body temperature, blood pressure, etc.) of the customer and/or facilitate biometric data communication with other computing devices (e.g., the locator 112, financial institution computing system 120, user device 106, etc.) directly or via a network (e.g., a private internal network associated with the financial institution, etc.). The network interface 138 may communicate over any of a variety of network protocols, including Ethernet, Bluetooth, WiFi, and the like. The account database 140 is structured to maintain accounts associated with customers of the financial institution and to facilitate transactions associated with the accounts. The account database 140 stores customer account information, including account numbers, account balances, customer contact information, customer preferences, and other account information.

Still referring to FIG. 1, customers of the financial institution can access the various services provided by the financial institution through the connected device 110. The connected device 110 may include wearable computing devices (e.g., a smartwatch, smart optical wear, etc.), personal computing devices such as laptops, digital assistance devices (e.g., a voice activated device configured to assist a user), PDAs, portable media devices, smartphones, tablet computing devices, vehicle infotainment systems (e.g., a computing device mounted inside of a vehicle and that includes a display and user input to present vehicle information, entertainment media, applications, navigation information and the like to passengers of a vehicle), etc. that may access one or more programs, servers, networks, central computers, etc. The connected device 110 may communicate with the financial institution computing system 120 of the financial institution through the network 114. In some arrangements, the network 114 includes the internet, cellular networks, personal area networks, WiFi networks, etc. The connected device 110 may execute a financial institution application associated with the financial institution. In some arrangements, the application is executed locally on the connected device 110 (e.g., a smartwatch, smart optical wear, etc.). Via the application, the connected device 110 may monitor various biometric conditions and/or information about the customer, access information about his or her accounts with the financial institution (e.g., balances, interest rates, etc.), pay bills, view automated teller machine (ATM) and branch locations, and view additional services offered by the financial institution. For example, the financial institution computing system 120 may be able to determine, via the connected device 110, the biometric state of a customer during a financial transaction as described in further detail herein.

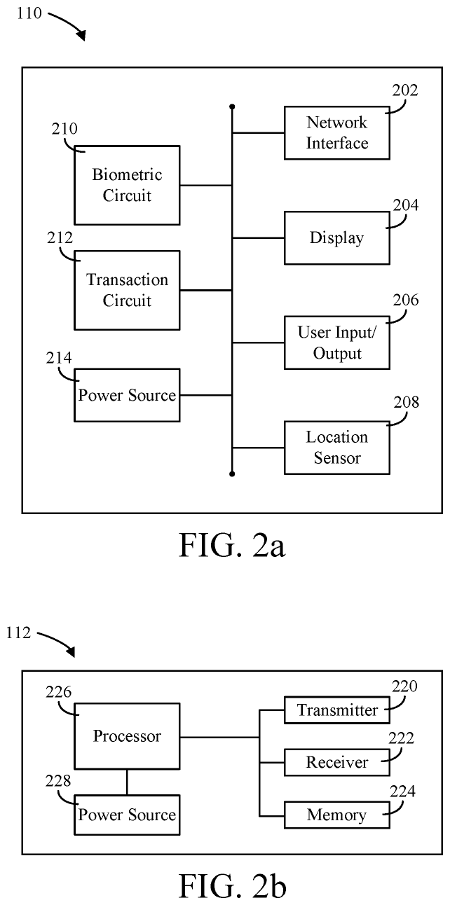

Referring to FIG. 2a, a block diagram of the connected device 110 is shown according to an example embodiment. As discussed above, the connected device 110 may be a wearable computing device (e.g., a smartwatch, smart optical wear, etc.), personal computing device, etc. The connected device 110 includes a network interface 202. The network interface 202 is a wireless network interface. The wireless network interface 202 includes any of a cellular transceiver (e.g., CDMA, GSM, LTE, etc.), a wireless network transceiver (e.g., 802.11X, ZigBee, Bluetooth, etc.), or a combination thereof (e.g., both a cellular transceiver and a Bluetooth transceiver). Additionally, the network interface 202 is capable of communicating with the financial institution computing system 120 via the network 114 (e.g., via any combination of the Internet, cellular networks, personal area networks, WiFi networks, etc.).

The connected device 110 may include a display 204 and a user input/output 206. In some arrangements, the display 204 and the user input/output 206 are combined (e.g., as a touchscreen display device). In other arrangements, the display 204 and the user input/output 206 are discrete devices. The user input/output 206 includes any of biometric sensors (e.g., a sensor configured to receive biometric data), speakers, keyboards, notification LEDs, microphones, buttons, switches, cameras, or a combination thereof. The biometric data may include data associated with vital signs, pulse rate, body temperature, blood pressure, blood flow, facial gestures, voice inputs, a visceral response system, a nervous system, cognition, typing input, or a combination thereof of the customer.

In some arrangements, the connected device 110 includes a location sensor 208. The location sensor 208 may be used to supplement location information determined based on the received position data. The location sensor 208 may be, for example, a GPS receiver, a GLONASS receiver, or the like.

The connected device 110 includes a power source 214. The power source 214 may include grid power, battery power (e.g., alkaline batteries, rechargeable batteries, etc.), and/or another energy source. In arrangements where the power source 214 is a rechargeable battery, the connected device 110 also includes circuitry configured to recharge the battery.

The functionality of the connected device 110 described herein is controlled at least in part by the biometric circuit 210 and the transaction circuit 212. Both the biometric circuit 210 and the transaction circuit 212 are formed at least in part by the financial institution application associated with the financial institution. The biometric circuit 210 is structured to monitor a biometric state of a customer during a financial transaction. The transaction circuit 212 is structured to allow a customer of the financial institution to execute or otherwise engage in financial transactions with the financial institution via the connected device 110 (e.g., transfer funds, withdraw funds, open accounts, close accounts, change beneficiary information, change contact information, etc.).

Referring to FIG. 2b, a block diagram of a locator 112 is shown according to an example embodiment. The locator 112 may be a Global Positioning System (GPS), beacon, or other position transmission system structured to receive, determine, and/or transmit position data by GPS coordinates, cellular network triangulation, etc. The locator 112 includes a processor 226 and memory 224. The memory 224 may include any combination of RAM, ROM, NVRAM, or the like as described herein. The locator 112 includes a radio frequency data transmitter 220. In some arrangements, the locator 112 is a two-way device and includes a receiver 222 capable of receiving radio frequency data transmissions. In such arrangements, the transmitter 220 and the receiver 222 may take the form of a transceiver capable of sending and receiving radio frequency data transmissions. The locator 112 includes a power source 228. The power source 228 may include any combination of grid power and battery power (e.g., alkaline batteries, rechargeable batteries, etc.).

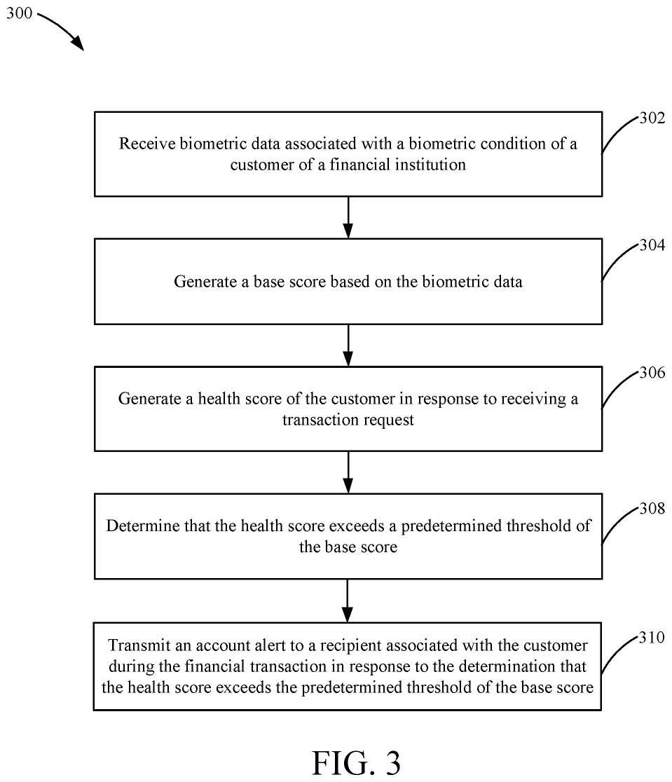

Referring to FIG. 3, a flow diagram of a method 300 of determining a biometric state (e.g., a state of duress, coercion, fraud, or a combination thereof) of a customer during a financial transaction is described according to an example embodiment. Method 300 may be performed by the biometric circuit 210 and/or the transaction circuit 212 of the connected device 110 such that reference may be made to the respective circuits to help explain the features, processes, and aspects of method 300. In some configurations, the biometric circuit 210 and/or the transaction circuit 212 of the connected device 110 may be communicatively connected to the biometric management circuit 130, the identification circuit 132, the location circuit 134, the calculation engine 136, and/or the account database 140 of the financial institution computing system 120. The flow diagram details the interaction between the connected device 110, the financial institution computing system 120, and various systems and/or devices associated with the customer (e.g., a user device 106, third party system 150, and locator 112). The connected device 110 may take the form of a wearable such as at least one of a smartwatch or smart optical wear, smartphone, tablet, digital assistance device (e.g., voice command device), or a combination thereof.

The method 300 begins when the connected device 110 receives, via the biometric circuit 210, biometric data associated with a customer of a financial institution at 302. The connected device 110 (e.g., a wearable computing device) may be provided to or otherwise utilized by a customer of the financial institution. The biometric condition of the customer includes at least one of a health state or cognitive state such that biometric data associated with the biometric condition may be derived from the customer of the financial institution. The biometric circuit 210 may receive the biometric data from one or more biometric sensors and/or circuits structured to detect biometric conditions or otherwise receive biometric data. The biometric data (e.g., biological data of a customer) may be utilized to assess the health or cognitive ability of the customer. In some arrangements, the biometric data may include data associated with vital signs, pulse rate, body temperature, blood pressure, blood flow, facial gestures, voice inputs, a visceral response system, a nervous system, cognition, typing input, or a combination thereof of the customer. In turn, the assessment of the biological data may be used to determine if the customer is under duress or being coerced when conducting a financial transaction. Alternatively or additionally, the assessment of the biological data may be used to determine whether the customer is more susceptible to fraud due to their health or cognitive ability.

In some configurations, the biometric circuit 210 of the connected device 110 may receive, via a third party system 150, biometric data associated with the customer. For example, biometric data associated with the customer may be received by the biometric circuit 210 via multiple devices in an internet of things (IoT) environment. In some arrangements, biometric data (e.g., medical data, fitness data, etc.) may be received or otherwise accessed by the biometric circuit 210 to determine the mental awareness (e.g., capacity) of the customer. The biometric data may be received or otherwise derived by the biometric circuit 210 via other third party systems such as, but not limited to, cognitive testing systems, healthcare provider systems, prescription systems, etc. associated with a customer account of the third party system 150 to leverage data collection and analysis. Based on the biometric data received via the third party system 150, the biometric circuit 210 may determine if a possible cognitive dysfunction or impairment may occur due to a medical condition, drug condition, etc. such that the customer is more susceptible to fraud. For example, the customer may be experiencing adverse reactions to drugs or an illness affecting cognitive abilities. The biometric circuit 210 may check the prescription drugs the customer is prescribed to determine whether those prescription drugs may affect cognitive abilities. Advantageously, fraudulent activity may be detected or discovered proactively before the transaction has been completed based on the biometric data and whether the cognitive ability of the customer is impaired. The biometric circuit 210 may transmit the biometric data to the account database 140 and/or another like database. The biometric data may be stored, tracked, or otherwise accessed from the account database 140 for analysis.

In a further example, the financial institution computing system 120 may receive, via the identification circuit 132, biometric data when the user is determined to be at the bank and/or ATM based on biometric data gathered from an audio and/or video surveillance device at or near the bank and/or ATM. The surveillance device may be positioned within the banking area, near the ATM area, and/or in the drive-through area. In some arrangements, the surveillance device may be configured to capture a video and/or audio of the customer before (e.g., 30 seconds, 60 seconds, etc. prior) the customer engages in a transaction, makes a payment. The surveillance device may be a blackbox or other surveillance device configured to capture audio and/or video. The audio and/video may be captured by the surveillance device during a fake screen load presented to the customer. In other arrangements, the surveillance device may be configured to receive biometric data of the customer based on an algorithm configured for biometric recognition (e.g., facial, finger, eye, hand, voice, etc. recognition associated with a particular user), etc. In turn, the biometric data may be derived or otherwise received by the identification circuit 132 of the financial institution computing system 120 based on the biometric recognition algorithm. The identification circuit 132 may provide the biometric data to the biometric management circuit 130 and/or the biometric circuit 210 for analysis.

In some configurations, the connected device 110 (e.g., a digital assistance device) may be configured to detect (e.g., listen to) a voice input of the customer. In turn, the biometric circuit 210 may receive biometric data based on the voice input (e.g., voice) of the customer. The voice input may be received by the user input/output 206 (e.g., microphone or other audio components) of the connected device 110. In further configurations, the connected device 110 may be configured to receive biometric data associated with the customer by testing the cognitive ability of the customer (e.g., using brain teasers), monitoring the typing input (e.g., the pattern and/or tempo) of the customer, etc. The connected device 110 may be configured to receive such biometric data in real-time or near real-time. Advantageously, the receipt of the biometric data in real-time or near real-time facilitates the determination of a fraud victim risk level of the customer and detects potential coercion of the customer when conducting a financial transaction in the presence of a caregiver or other third party. The biometric data received may be used to generate or otherwise establish a base score (e.g., a baseline health and/or cognitive ability score) associated with the customer at 304 by the biometric circuit 210. As used herein, the term “base score,” may be used to refer to a score indicative of a normal cognition level of the customer. In some arrangements, the base score may be generated by the financial institution computing system 120 (e.g., via the calculation engine 136 and biometric management circuit 130) and transmitted to the connected device 110 for comparison to a health score as described herein.

The financial institution computing system 120 may be configured to receive, via the locator 112 and/or the connected device 110, location data associated with the customer. In some arrangements, the connected device 110 transmits location data determined based on GPS coordinates, cellular network triangulation data, etc., to the financial institution computing system 120. The location data may indicate the position of the customer as the biometric data is received. For example, the connected device 110 may indicate that the customer is at a location (e.g., a home address) associated with the account of the customer stored in the account database 140. The connected device 110 may indicate that the customer is at any other location (e.g., at a bank, ATM, or other location associated with the financial institution) determined, via the locator 112, by GPS coordinates, cellular network triangulation data, etc. In some configurations, the location data may be determined by or related to the locator 112 (e.g., a beacon identifier). In such configurations, the financial institution computing system 120 may identify, via the location circuit 134, banks and/or ATMs in the vicinity of the connected device 110. In arrangements where the location data relates to other location data (e.g., GPS coordinates), the financial institution computing system 120 may cross-reference the location of the connected device 110 against the known locations of the banks and/or ATMs to determine whether the customer is within a predetermined range of a given bank and/or ATM to determine the position of the customer as the biometric data is received.

In further configurations, the financial institution computing system 120 may be configured to receive, via the locator 112, location data associated with the user device 106 (e.g., a user device of another party). The financial institution computing system 120 may determine, via the location circuit 134, that another party is near or otherwise proximate to the customer. For example, the locator 112 may receive the location data of each respective user device 106 that is within a proximate range of the connected device 110. The location data may be provided to or otherwise received by the location circuit 134 of the financial institution computing system 120. In some configurations, the location circuit 134 may provide the location data to the calculation engine 136 which may determine whether another party is within a proximate range of the customer. Alternatively or additionally, the location circuit 134 may determine that another party (via the location data of the user device 106) is within a proximate range of the customer (via the location data of the customer device 110). In turn, the biometric management circuit 130 of the financial institution computing system 120 and/or the biometric circuit 210 of the connected device 110 may determine the biometric state of the customer when the other party is near or proximate to the customer based on the location data received. For example, the biometric management circuit 130 of the financial institution computing system 120 and/or the biometric circuit 210 may determine whether the customer is nervous or uncomfortable when the third party is near (e.g., by comparing the biometric state of the customer with the base score).

The connected device 110 may be configured to receive a voice input associated with another party. The system may also determine that the other party is a bad actor (e.g., a fraudster or potential fraudster) based on a determination that the biometric condition (e.g., the vital signs, pulse rate, body temperature, blood pressure, etc.) of the customer varies or otherwise changes when the customer is proximate to the other party. For example, the biometric condition of the customer may indicate that the customer is nervous, or uncomfortable around the other party. In further arrangements, the connected device 110 may determine the biometric state of the customer when the other party is proximate to the customer based on the voice input associated with the other party. The voice input may include a voice key (e.g., key words, phrases, or characters) structured to indicate coercion. For example, a conversation with another party such as a caretaker may be received or otherwise detected via the connected device 110 (e.g., an always on device) associated with circuitry of the financial institution. The voice conversation may contain a voice key (e.g., key words) which indicates possible coercion of the customer. For example, the voice key “Just sign here,” “You don't need to read this before you sign it,” etc. Further, data can be used to determine if proper care is being provided to the customer and whether possible coercion is being applied to the customer by a third party.

The financial institution computing system 120 may be configured to generate, via the connected device, a health score associated with the customer at 306. The term “health score” as used herein may refer to a score structured to indicate the health of the customer based on the biometric data including physical health data and/or cognitive health data. As the connected device 110 monitors the biometric condition of the customer, the connected device 110 may provide or otherwise transmit the biometric data associated with the biometric condition of the customer to the financial institution computing system 120. The calculation engine 136 of the financial institution computing system 120 may generate the health score based on the biometric data received. For example, the calculation engine 136 may generate the health score of a customer based on biometric data, such as the heart rate, blood pressure, breathing rate, or any other biometric alone or in combination.

Prior to allowing the customer to initiate a financial transaction, the customer is authenticated as an account holder. In arrangements in which the financial transaction is initiated via a financial user interface associated with the financial institution (e.g., via an ATM user interface, mobile banking user interface, application based user interface, etc.), the connected device 110 receives and transmits user authentication data (e.g., data indicative of the identity of a customer) to the financial institution computing system 120. The user authentication data includes any of a password, a PIN (personal identification number), a user ID, an answer to a verification question, a biometric (e.g., a picture of the user's face, a fingerprint, a voice sample, a retina scan, etc.), an identification of a security image, or a combination thereof. The financial institution computing system 120 compares the received authentication data with known and verified user authentication data. If the authentication data provided does not match the known and verified user authentication data, the customer is not authenticated. If the authentication data provided matches the known and verified user authentication data, the customer is authenticated such that the biometric state of the customer may be determined during the financial transaction.

At 308, the connected device 110 may be configured to determine, via the connected device 110, the biometric state of the customer during the financial transaction based on the health score exceeding a predetermined threshold of the base score. Accordingly, the calculation engine 136 may transmit the health score generated at 306 to the biometric circuit 210 of the connected device 110. In turn, the biometric circuit 210 may compare, via the connected device 110, the health score to the base score at 308. In some arrangements, the calculation engine 136 may provide the health score to the biometric management circuit 130 of the financial institution computing system 120. In such arrangements, the biometric management circuit 130 may compare the health score to the base score. In further arrangements, the biometric management circuit 130 may transmit the health score to the connected device 110 for comparison to the base score. If the health score is less than or otherwise meets a predetermined threshold of the base score during the financial transaction (e.g., when the customer initiates a funds withdrawal, funds transfer, beneficiary change, etc. from their account at the financial institution), the biometric circuit 210 may determine that the biometric state of the customer is not indicative of duress or coercion. If the health score exceeds the predetermined threshold of the base score during the financial transaction (e.g., when the customer begins to withdraw funds from their account at the financial institution), the biometric circuit 210 may determine that the biometric state of the customer is indicative of duress or coercion. In some configurations, the comparison of the health score to the base score may be based on a time period, location, etc. For example, the customer may have a higher heart rate yielding generally the same or similar health score every time the customer goes to the bank such that the comparison of the health score to the base score does not indicate a biometric state of duress or coercion.

In some configurations, the biometric circuit 210 may be configured to determine a change in the biometric state of the customer. The change in the biometric state may be based on a time period, location, etc. Accordingly, the biometric data may be analyzed by the biometric circuit of connected device 110 and/or the financial institution computing system 120 programmatically utilizing machine learning to develop a particular pattern recognition algorithm that utilizes statistical inferences to determine a change in the biometric state of the customer based on the time period, location, etc. Such machine learning may be unsupervised or supervised such that the biometric circuit 210 may determine hidden structure from unlabeled data or infer a function from a set of training patterns placed into a classifier to map new data (e.g. new inferences of the biometric state of the customer) based the learned training patterns. Accordingly, the biometric condition of the customer may be monitored, via the connected device 110, to determine changes in the health and/or the cognitive ability of customer during a period of time, at a location, or a combination thereof. For example, the heart rate of the customer during a current visit to the bank or ATM or while executing a financial transaction may have increased causing a health score which exceeds the previous learned health scores of the customer. The increase in health score as compared to the base score may indicate a biometric state of duress or coercion. The associated biometric data of the customer may be stored in or otherwise retrieved from the account database 140 or memory associated with the financial institution computing system 120 or the connected device 110.

In some arrangements, the biometric circuit 210 may be configured to determine whether an event risk (e.g., a fraud risk, fraud risk level, etc.) exceeds an event threshold (e.g., a threshold risk level indicative of fraud or coercion) based on the health score (e.g., a score indicative of physical health and/or cognitive ability) exceeding the predetermined threshold of the base score (e.g., a baseline health and/or cognitive ability score). For example, if the health score exceeds the predetermined threshold of the base score which indicates that the biometric state of the customer is indicative of duress or coercion, the biometric circuit 210 may determine that the risk of fraud or coercion exceeds the event threshold.

At 310, an account alert is provided, via the connected device, to an associated recipient during the financial transaction in response to the health score exceeding the predetermined threshold of the base score. Alternatively or additionally, an account alert may be provided to an associated recipient during the financial transaction when the event risk exceeds the event threshold. In some examples, an account alert may be provided to an associated recipient and/or the financial institution when the event risk exceeds the event threshold even if the customer is not engaging in a financial transaction. The associated recipient may include at least one of a family member, guardian, healthcare provider, emergency response personnel, law enforcement personnel, or designated recipient. The associated recipient (e.g., a family member or guardian) may receive the account alert via a user device 106 such that the associated recipient may be informed of the event risk.

In further embodiments, an account of the customer may be moved to a held state (e.g., a state in which no activity, such as transactions, may be executed or otherwise completed with respect to the account) in response to the event risk exceeding the event threshold. For example, when an event risk (e.g., a risk of coercion) is detected, the biometric circuit 210 and/or the biometric management circuit 130 may execute an anti-fraud action, such as putting a hold on the account such that the customer may not complete a withdrawal, funds transfer, beneficiary change, etc. In some example configurations, the biometric circuit 210 and/or the biometric management circuit 130 may execute an anti-fraud action, such as putting a partial hold on the account such that the customer may complete a partial withdrawal or funds transfer (e.g., a withdrawal or funds transfer for a percentage amount (e.g., 10%, 25%, 50%, etc.)) of the total requested funds. Yet in other configurations, the biometric circuit 210 and/or the biometric management circuit 130 may execute an anti-fraud action, such as putting a partial hold on the account and requiring a designated amount of time (e.g., 24 hours) to pass before the balance of the requested funds may be withdrawn or transferred. In further configurations, the biometric circuit 210 and/or the biometric management circuit 130 may set metadata flags to allow a first financial transaction (e.g., a fraudulent and/or coerced transaction) to complete, but not a subsequent financial transaction (e.g., a subsequent fraudulent and/or coerced transaction) to complete.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An example system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A method of determining a biometric state of a customer during a financial transaction, the method comprising:
receiving, via a connected device, biometric data associated with a biometric condition of a customer of a financial institution and during a first time period before receiving a transaction request;
receiving, via the connected device, location data associated with a position of the customer determined based on a global positioning system (GPS) coordinate of the connected device at the time the biometric data is generated, wherein the position of the customer indicates that the customer is at a location associated with the account of the customer;
generating, via the connected device, a base score based on biometric data;
monitoring, via the connected device in real-time, the biometric condition of the customer and receive additional biometric data during a second time period when the connected device provides information to a third party system;
receiving, via the connected device, additional location data associated with a second position of the customer determined based on a GPS coordinate of the connected device at the time the additional biometric data is generated;
generating, via the connected device, a health score of the customer based on the additional biometric data and the typing input in response to receiving the transaction request for the account of the customer at the financial institution from the third party system;
receiving, via the connected device, voice input associated with a third party during the second time period, wherein the voice input comprises a voice key indicating a first state of duress, coercion, fraud, or a combination thereof;
determining, via the connected device, the GPS coordinate of the connected device is within a predetermined range of a financial institution computing system;
in response to determining the connected device is within the predetermined range, determining, via the connected device in real-time, a biometric state of the customer based on the health score exceeding a predetermined threshold of the base score, the additional location data of the customer, and the voice input, wherein the biometric state indicates a second state of duress, coercion, fraud, or a combination thereof; and
transmitting, via the connected device, an account alert to a recipient associated with the customer prior to authorizing the transaction request, the account alert indicating the determined biometric state of customer.

2. The method of claim 1, wherein the biometric condition comprises at least one of a health state or cognitive state, wherein the biometric data comprises data associated with vital signs, pulse rate, body temperature, blood pressure, blood flow, facial gestures, voice inputs, a visceral response system, a nervous system, cognition, typing input, or a combination thereof of the customer.

3. The method of claim 1, further comprising receiving, via the third party system, the biometric data associated with the customer.

4. The method of claim 1, further comprising determining whether an event risk exceeds an event threshold based on the health score exceeding the predetermined threshold of the base score.

5. The method of claim 1, further comprising utilizing machine learning to develop a particular pattern recognition algorithm to determine a change in the biometric state of the customer based on a time period, location, or combination thereof.

6. (canceled)

7. The method of claim 1, wherein the connected device comprises a wearable comprising at least one of a smartwatch or smart optical wear, digital assistance device, or a combination thereof, and wherein the transaction request comprises at least one of a withdrawal, funds transfer, or beneficiary change.

8. The method of claim 1, wherein the account of the customer is moved to a held state in response to an event risk exceeding an event threshold.

9. The method of claim 1, further comprising:
receiving location data associated with a user device of a third party; and
determining a biometric state of the customer when the user device is proximate to the customer based on the received location data.

10. (canceled)

11. A banking system comprising:
a connected device comprising a biometric sensor, the connected device configured to receive, via the biometric sensor, biometric data associated with a biometric condition of a customer of a financial institution;
a computer system communicatively coupled to the connected device, the computer system configured to:
receive the biometric data during a first time period before receiving a transaction request;
receive location data associated with a position of the customer determined based on a global positioning system (GPS) coordinate of the connected device at the time the biometric data is generated, wherein the position of the customer indicates that the customer is at a location associated with an account of the customer;
generate a base score based on the biometric data;
monitor, in real-time, the biometric condition of the customer and receive additional biometric data during a second time period when the connected device provides information to a third party system;
receive additional location data associated with a second position of the customer determined based on a GPS coordinate of the connected device at the time the additional biometric data is generated;
generate a health score of the customer based on the additional biometric data and the typing input in response to receiving the transaction request for the account of the customer at the financial institution from the third party system;
receive, from the connected device, voice input associated with a third party during the second time period, wherein the voice input comprises a voice key indicating a first state of duress, coercion, fraud, or a combination thereof;
determine the GPS coordinate of the connected device is within a predetermined range of a financial institution computing system;
in response to determining the connected device is within the predetermined range, determine, in real-time, a biometric state of the customer based on the health score exceeding a predetermined threshold of the base score, the additional location data of the customer, and the voice input, wherein the biometric state indicates a second state of duress, coercion, fraud, or a combination thereof; and
transmit an account alert to a recipient associated with the customer prior to authorizing the transaction request, the account alert indicating the determined biometric state of the customer.

12. (canceled)

13. The system of claim 11, wherein the biometric condition comprises at least one of a health state or cognitive state, and wherein the biometric data comprises data associated with vital signs, pulse rate, body temperature, blood pressure, blood flow, facial gestures, voice inputs, a visceral response system, a nervous system, cognition, typing input, or a combination thereof of the customer.

14. (canceled)

15. The system of claim 11, wherein the computer system is further configured to receive, via the third party system, the biometric data associated with the customer.

16. The system of claim 11, wherein the computer system is further configured to determine whether an event risk exceeds an event threshold based on the health score exceeding the predetermined threshold of the base score.

17. The system of claim 11, wherein the computer system is further configured to establish at least one of the biometric data or the base score associated with the customer.

18. The system of claim 11, wherein the connected device comprises a wearable comprising at least one of a smartwatch or smart optical wear, digital assistance device, or a combination thereof.

19. The system of claim 11, wherein the transaction request comprises at least one of a withdrawal, funds transfer, or beneficiary change.

20. The system of claim 11, wherein the account of the customer is moved to a held state in response to the determination of the health score exceeding the predetermined threshold.

21. The system of claim 11, wherein the computer system is further configured to:
receive third-party location data associated with a third position of the third party; and
determine the biometric state of the customer when the third party is proximate to the customer based on the third-party location data received.

22. A connected system for determining a biometric state of a customer, the connected system comprising:
a financial institution computing system; and
a connected device communicatively coupled to the computer system, the connected device configured to:
receive biometric data associated with a biometric condition of a customer of the financial institution and during a first time period before receiving a transaction request;
receive location data associated with a position of the customer determined based on a global positioning system (GPS) coordinate of the connected device at the time the biometric data is generated, wherein the position of the customer indicates that the customer is at a location associated with an account of the customer;
generate a base score based on the biometric data;
monitor, in real-time, the biometric condition of the customer and receive additional biometric data during a second time period when the connected device provides information to a third party system;
receive additional location data associated with a second position of the customer determined based on a GPS coordinate of the connected device at the time the additional biometric data is generated;
generate a health score of the customer based on the additional biometric data and the typing input in response to receiving the transaction request for the account of the customer at the financial institution from the third party system;
receive, from the connected device, voice input associated with a third party during the second time period, wherein the voice input comprises a voice key indicating a first state of duress, coercion, fraud, or a combination thereof;
determine the GPS coordinate of the connected device is within a predetermined range of a financial institution computing system;
in response to determining the connected device is within the predetermined range, determine, in real-time, a biometric state of the customer based on the health score exceeding a predetermined threshold of the base score, the additional location data of the customer, and the voice input, wherein the biometric state indicates a second state of duress, coercion, fraud, or a combination thereof;
transmit an account alert to a recipient associated with the customer prior to authorizing the transaction request, the account alert indicating the determined biometric state of the customer; and
place a hold on an account of the customer based on the biometric state of the customer.

23. The system of claim 22, wherein the biometric state of the customer is determined during a pendency of the transaction request.

24. (canceled)

25. The system of claim 22, wherein the biometric condition comprises at least one of a health state or cognitive state, wherein the biometric data comprises data associated with vital signs, pulse rate, body temperature, blood pressure, blood flow, facial gestures, voice inputs, a visceral response system, a nervous system, cognition, typing input, or a combination thereof of the customer.

26. The system of claim 22, wherein the connected device is further configured to receive, via the third party system, the biometric data of customer.

27. The system of claim 22, wherein the connected device is further configured to determine whether an event risk exceeds an event threshold based on the health score exceeding the predetermined threshold of the base score.

28. The system of claim 22, wherein the account of the customer is moved to a held state in response to the determination of the health score exceeding the predetermined threshold.

29. The system of claim 22, wherein the connected device is configured to receive, via a biometric sensor, the biometric data.

30. The system of claim 22, wherein the connected device is configured to determine the mental awareness of the customer.
